(19) United States
(12) Patent Application Publication
(10) Pub. No.: US 2003/0059015 A1
(43) Pub. Date: Mar. 27, 2003

(54) Call server allowing calls with multiple participants and multiple services independently of the number of participants

(76) Inventors: Mello Eber, Ottawa (CA); Giuseppe Cinotti, Kanata (CA)

Correspondence Address: MARKS & CLERK, 350 BURNHAMTHORPE ROAD WEST, SUITE 402, MISSISSAUGA, ON, L5B 3J1, CA

(21) Appl. No.: 09/957,671

(22) Filed: Sep. 21, 2001

(51) Int. Cl. H04M 3/42; H04M 7/00

(52) U.S. Cl. 379/201.02; 379/219

(57) ABSTRACT

A call server which permits from zero to multiple call-legs per call also permits multiple services independently of the number of participants in any call being established or already established. A finite state machine logic device is established for each call so as to capture the evolution of the call during its lifetime, and to enable the call server to handle and process signalling messages from endpoints associated with the call and of requests from call services running on the call server during that call. The finite state machine logic device changes state during the progress of a call, in keeping with instructions that it receives as the call evolves. At any time, any service associated with any call-leg of that call may alter the by processing of the call in keeping with predetermined instructions associated with that service. The finite state machine logic device may be associated with the call server, or any call leg established for a call, or both.

### FIELD OF THE INVENTION

This invention relates to call servers, and particularly to call servers which are used in association with telephony. The present invention finds particular utility in the field of VOIP (Voice Over Internet Protocol) telephony, where telephone calls are made from and between parties using IP (Internet Protocol).

### BACKGROUND OF THE INVENTION

Whenever a call is made using the VOIP telephony, the call will be routed through one or more call servers. Typically, a call is initiated by a user or originating party; but calls may sometimes be initiated by a call server—that is to say by a service which may be associated with or running on the call server. Moreover, there may be many different types of calls, having regard to the number of participants in the call or how the call was established or initiated.

In order to work in such environment, a call server such as the flexible call server of the present invention must be able to support different types of calls both with regards to the number of participants in the call, as well as having regard to how the call was established or initiated. For example, a call may have been established or initiated by any user who is connected to a network to which the call server is also connected—typically through the Internet—or the call may have been established by a service which is executed within the call server itself.

Any call which is established on a call server may have zero participants, in which case it may function as an empty virtual conference room into which participants may call in to join an existing conversation. A call may have a single participant, for example when an “alarm” or “wake-up” call is initiated by the call server. Of course, a call may have two participants, which is the usual configuration in a typical two-party call; or a call may have multiple participants such as in the case of a conference call.

Finite State Machines (FSM) are logic devices which are well known in the art, whose purpose in the present invention is to capture the evolution of a call during its lifetime, and to enable different call configuration with regard to the number of participants during any call. The goal and purpose of this finite state machine is to keep enough context of the call so that the call server can treat signalling messages from the endpoints in the network, as well as requests from the services running on the call server, in a correct and predictable way.

The call server breaks up the process of placing and receiving calls into a set of states, so as to give the services associated with the call server the opportunity to control and interfere with the call processing. A “call-leg” is defined as the relationship of the call and an endpoint within the call. For example, the call-leg between a call server and an originating endpoint is defined as the “originating call-leg”; and the relationship of a call-leg between the call server and any terminating endpoint is defined as a “destination call-leg”.

An Invite message is defined by IETF 2543 (SIP), and is used by an endpoint to invite another party into a call. This Invite message may have been received from the network, in the case of a traditional call, or it may have been created by a service associated with the call server. The call server also allows multiple services to run in parallel—that is to say, contemporaneously—because the act of sending or having the intention to send an Invite message to a user that owns a service associated with that call server may trigger the execution of another service of the destination user. For example, if user “A” calls user “B”, who forwards incoming calls to user “C”, then user “B” has a service running on that call server to forward calls elsewhere. Also, if user “C” has services running on the call server, then both users' services will be executed on the same call-leg; provided, of course, that the services of both users are located on the same call server.

### SUMMARY OF THE INVENTION

In accordance with one aspect of the present invention, there is provided a call server which permits from zero to multiple call-legs per call. The present invention also provides a call server which will permit multiple services to be running independently of the number of participants in any call.

To that end, the present invention provides for the call server to be adapted to establish a finite state machine logic device for each call that is being established, so as to capture the evolution of the call during its lifetime, and so as to enable the call server to handle and process signalling messages from endpoints associated with the call and of requests from call services running on the call server during any call.

The finite state machine logic device will change its state during the progress of a call, in keeping with instructions received by that finite state machine logic device as the call evolves.

At any time, any service associated with any call-leg of any call may alter the processing of that call in keeping with predetermined instructions associated with the respective service.

In particular, the finite state machine is a call finite state machine which is such as to permit a call to be initiated by any one of a call service associated with the call server, or an endpoint which is associated with the call server.

In keeping with other provisions of the present invention, the call server may further comprise a finite state machine for an originating call-leg between an originating endpoint, and the call server.

Also, in keeping with further provisions of the present invention, any call may include a plurality of destination endpoints, and a corresponding plurality of terminating call-legs. If so, the call server may further comprise at least one finite state machine for at least one of the terminating call legs between the call server and any destination endpoint for that call.

The present invention provides that a plurality of services may be permitted to run contemporaneously in association with any call-leg of a call.

The present invention also provides that the state of the call finite state machine logic device may be defined by the number of call-legs at any instant in time during the lifetime of a call.

Moreover, the state of the call finite state machine logic device may be defined as a consequence of any signalling messages received by the finite state machine logic device from any network endpoint associated with that call, or of any requests that are received by the finite state machine logic device from any call service running on the call server.

A particular state of the call finite state machine logic device may be chosen from the group consisting of: zero call-legs, one call-leg, two call-legs, and multiple call-legs.

Still further, the state of the call finite state machine logic device may be chosen from the group consisting of: processing incoming Invite, routing call, and idle.

During the life of any call, auxiliary information may be kept by the call finite state machine logic device on a per call-leg basis, for each call-leg associated with that call.

A detection point may exist in the finite state machine for the originating call-leg, at any transition of the originating call-leg from one state to another. Accordingly, any service associated with that call-leg may be invoked by the call server when a detection point occurs.

Moreover, a detection point may also exist in the at least one finite state machine for the at least one terminating call-leg of the call, at any transition of that at least one terminating call-leg from one state to another, so that any service associated with the respective at least one terminating call-leg may be invoked by the call server when a detection point occurs.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 represents the architecture of the typical multi-party call in keeping with the present invention;

FIG. 2 shows a typical scenario for change of call states of a call finite state machine logic device for a first kind of a call being established;

FIG. 3 is similar to FIG. 2, but showing a different scenario for a different kind of call being established;

FIG. 4 shows yet a different scenario for yet a different kind of established call;

FIG. 5 shows a scenario where no service interferes with the call;

FIG. 6 shows an event sequence as signalling messages and requests for services are processed by an originating call-leg finite state machine logic device; and

FIG. 7 FIG. 7 is similar to FIG. 6, but showing an event sequence as signalling messages and requests for services are being processed through a terminating call-leg finite state machine logic device.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

Several particular features of the present invention will be outlined in greater detail hereafter. They include the fact that several finite state machine logic devices will be established in the call server, or may be established, for any call. The first of those is designated the call finite state machine or call FSM, whose purpose is to enable different call configurations with regard to both the number of participants, as well as to how the call is initiated—either by endpoints on the network, or by a service within the call server. Of course, other call-leg FSM's may also exist, both in the originating call-leg and in any terminating call-leg. Their purpose permits them to trigger services within the call server, and to allow them to control and/or monitor the evolution of the call.

It has been noted that a purpose of the present invention is to provide a call server that will permit multiple services to be triggered and executed in parallel—that is, contemporaneously—within the context of a particular call-leg. Moreover, multiple services may be triggered and executed in parallel within the context of different call-legs, but on the same call.

Finally, it will be discussed that the call server of the present invention allows for a request that is issued by a service running on a call leg to be consolidated with all services running on that call.

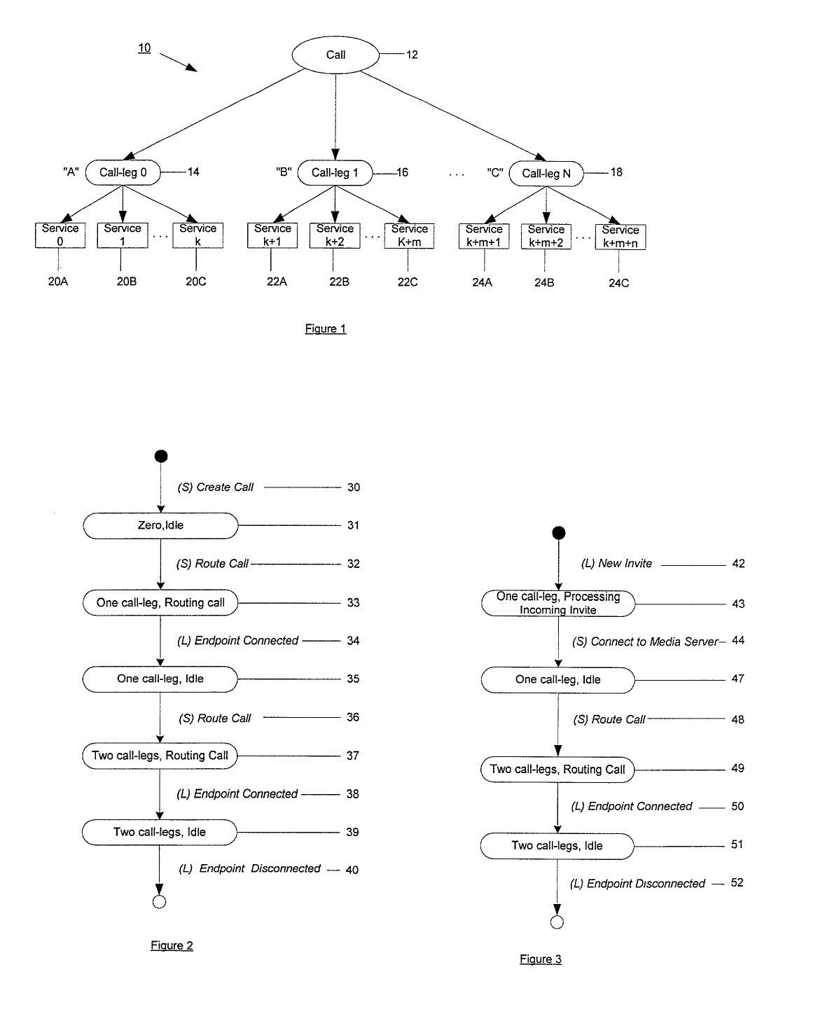

A key responsibility of the call server of the present invention is to trigger the execution of services that are interested in interfering or monitoring a specific call as it is being established, or after it has been established. Moreover, the call server will accept and execute requests from both services, and from the endpoints on the network, and it will keep the services informed of any important state changes during the call. The architecture of a typical multi-party call being routed through a call server is shown in FIG. 1, and is now discussed.

The architecture of any call is shown in general terms at 10, in FIG. 1. The call 12 may consist of a number of call-legs, identified as “call-leg 0”, shown at 14; “call-leg 1”, shown at 16; and up to “call-leg N”, shown at 18.

Each of the call legs may themselves have a plurality of services associated with them, as shown at 20A, 20B, 20C; 22A, 22B, 22C; 24A, 24B, 24C.

Obviously, the purpose of FIG. 1 is to show the associations between the call 12 and any of the call-legs 14, 16, 18; and between any of the call-legs and their services. Many services can be triggered to run independently of the number of call-legs in a call—not all or any of the services need to be running—and any of the services can be triggered to run notwithstanding that other services are already running on any specific call-leg.

The entity of the call 12 is responsible for achieving the overall goal of the call. For instance, messages are routed between two call-legs, which may be any of the call-legs, in a traditional two-party call, when one user calls another. Take, for example, a call between a user “A”, who is associated with call-leg 14, and a user “B”, who is associated with call-leg 16. Otherwise, the call entity associated with call 12 may be responsible for managing a multi-party call, such as when different users “A”, “B”, and “C”, call in to join a conference. Each of the call-legs is quite unaware of the type of call that they are involved in—one-party, two-party, or multi-party—and each call-leg in any call processes messages from the respective endpoints to the call server, and messages from the call server to the endpoints, as defined by respective call-leg finite state machine logic device—a “call-leg FSM”.

Any call-leg may, while processing messages, either invoke services as well as receive requests from them. Thus, each time a service is invoked it is executed in the context of the invoking call-leg.

As noted above, multiple services may run on a single call-leg; and each service is unaware of the existence of other services that are running on that same call-leg. Whenever a request is issued by a service, or a message is received from the network, the respective call-leg will consolidate the request or message received, with other services that are running on that call-leg. However, if no other service is willing to interfere with the call processing, then the request or message is processed according to default rules.

For example, if an endpoint sends a disconnect request message to release itself from the call, then that message will be routed to the other party—in a two party call—only if no other existing service is interested in modifying that behaviour, or interfering with the disconnect request message.

In any call, each call-leg will evolve to an active state. When a call-leg is in its active state, the endpoint associated with it is ready to transmit and to receive media. However, a call-leg can evolve from one state to another due to a message which is received from the network, or a message which is sent by the call 12, or due to an internal event. Of course, it is recognized that all messages to an endpoint are sent through the call-leg which is associated with that endpoint.

The transition of a call-leg state from one state to another is discussed hereafter.

When the call FSM is established, it will have two variables which define each state of the call FSM. They are the variable which determines the number of call-legs in a call, and the variable which determines the current pending request.

Whenever a user, or party, sends an Invite to the call server to join an existing call, or to create a new call, an originating call-leg is created. For example, if user “A” in FIG. 1 has sent an Invite to the call server, then call-leg 14 is the originating call-leg. If that caller is subscribed to a service, then the service is triggered to run when the call server receives the Invite from that user. Thus, the service is said to “run” on the originating call-leg. Thus, any of services 20A, 20B, or 20C will be said to run on call-leg 14.

On the other hand, a terminating call-leg will be created, such as call-leg 16 or call-leg 18 in the present example, in order to Invite a destination user “B” or “C”, or both, into a call 12. If any destination user has services that are triggered to run during the process of sending an Invite message to that user, then those services 22A. 22B, or 22C in the case of user “B”, or 24A, 24B, and 24C in the case of user “C”, are said to run on the respective terminating call-leg 16 or 18. Indeed, any user to whom an Invite message has been forwarded, and who owns a service, will also have his or her service or services running on the same respective terminating call-leg.

When a call is active, there are as many call-legs in the call as there are users associated with that call. Thus, the following values are allowed for the number of call-legs in a call:

Zero Call-Legs

Whenever a service or a call server creates a call, that call is empty of participants at that time. Users can then join the call, either by calling in, or the service can invite users into the call by calling them.

One Call-Leg

This can be either an originating call-leg or a terminating call-leg, in the sense described above. A typical example of a call having but one call-leg is such when the call server itself accepts an incoming call, and connects the caller to a media server—which will then be capable to function as an endpoint, either playing announcements or collecting voice commands or DTMF-based information. Another example is when the call server itself might call a user, to leave him or her a message.

Two Call-Legs

A classic call, from one party to another, has two call-legs. The first represents the caller who originates the call, and is thus the originating call-leg; and the other call-leg represents the user who has been called, thus being the terminating call-leg. However, it should be noted that a classic call from a first user to another user is not the only kind of call that can have two call-legs. Another example might be a call which has been initiated by a service that created the call, and invited two different users into it.

Multiple Call-Legs

In this case, such as shown in FIG. 1, there may be an unlimited number of parties that are able to communicate one to another, within the same call. A typical scenario is that of a conference call, where users can call in to join the call, or can be invited by other users.

The other variable which defines each state of the call FSM is the current pending request. All requests that are received from an endpoint on the network, or from a service that cannot be instantaneously executed, will require the call FSM to keep the information that the request is in progress. Those values are defined as follows:

Processing Incoming Invite

In this state, a request to join an existing or established call, or to create one if it does not yet exist, has been received, and is being processed by the call server.

Routing Call

The original Invite has been received from an endpoint, or an Invite that has been created by a service is about to be sent or has already been sent out to destination on the network.

Idle

No request is being performed by the call FSM at that time.

Still further, auxiliary information is kept on a per call-leg basis, in order to help the call FSM correctly process requests from the network or from services associated with the call server of with any user that is a party to the call. Such auxiliary information that is kept on a per call-leg basis includes:

Information as to whether the specified call-leg is active or not. A call-leg is said to be active if the endpoint to which it is associated is ready to transmit media.

Information as to whether the respective call-leg is an originating call-leg or a terminating call-leg.

Information as to whether the respective call-leg is connected to a media server, or if it is not connected to a media server.

Information as to whether the specified or respective call-leg is being re-routed or not. A call-leg may be re-routed in order to change the destination of the media that the endpoint associated with that call-leg is transmitting.

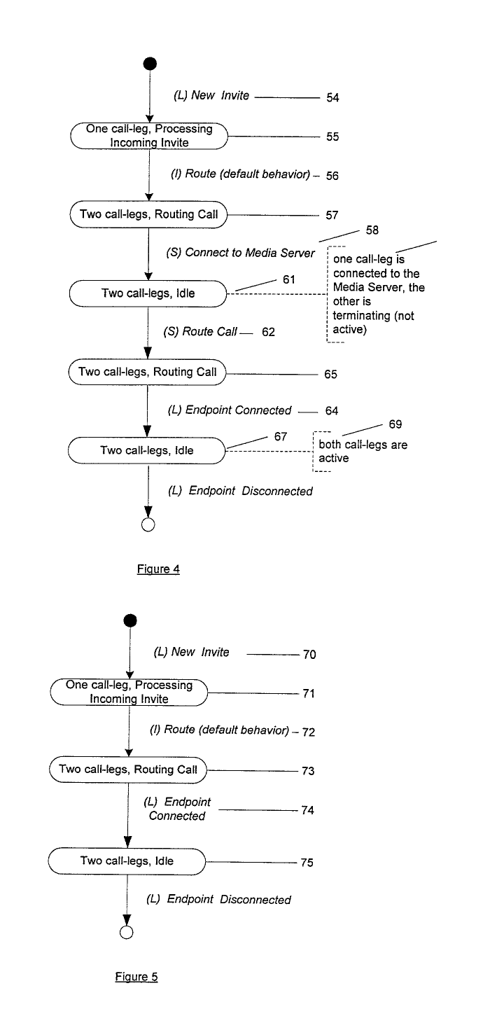

Several application scenarios that can be executed using the call finite state machine logic device, in keeping with aspects of the present invention, are now described with respect to FIGS. 2 to 5.

It should be noted, in the following discussion, that some call states are repeated for the sake of making the flow easier to follow. Explanations as to each event name in each transition are given below, and are indicated in the Figures, and they represent the origin of the message that triggered the particular transition.

In FIGS. 2 to 5, the letter “S” indicates that the origin of the message that triggered the particular transition is a service to which a party has subscribed, or which is found on the call server. The letter “L” indicates that the origin of the message that triggered the specific transition is on the call-leg itself; and the letter “I” indicates that the origin of the message that triggered the specific transition is internal of the call server.

Referring to FIG. 2, a scenario is shown where a service will create an empty call and invite two parties into it so that they can communicate. Such a circumstance may occur, for example, when a user on the Internet clicks a button on a web page, and the service connects that user by calling him or her, and an agent who is associated with the web page.

It is assumed in this discussion that when one endpoint disconnects, the other endpoint will also be disconnected from the call.

The call is created at 30, by the service, but at that instant in time the state of the call FSM is that it has zero call-legs, and that it is idle, as shown at 31. Then, at 32, the service routes the call, so that the state of the call FSM at 33 becomes such that it has one call leg, and that the call is being routed. When the endpoint is connected at 34, then the next transition at 35 is to the state of having one call-leg, and the call FSM is idle.

However, thereafter the call is again routed by the service at 36; and this transition leads to the state at 37 where the call FSM now has two call-legs, and is routing a call.

Once the other endpoint is connected, at 38, then the call FSM has two call-legs, but it becomes idle because it is no longer performing any request to it.

Then, when an endpoint disconnects as at 40, the established call is disestablished, and the previously existing call FSM which was established for that call is dissolved.

Turning now to FIG. 3, a new scenario is shown where a service which is associated with the caller's address accepts the call, and then connects the associated endpoint to a media server. An example of such scenario is such that the service will let the user know that he or she has new messages on a voice mailbox. The call server then invites the called party into the call. Once again, when one endpoint disconnects, the other endpoint is also disconnected from the call.

A new Invite is received by the Call Server as shown at 42, giving rise to a call FSM state as shown at 43 where the call FSM has one call-leg, and is processing the incoming Invite message. The next transition is shown at 44, where the service for that user connects the caller to a media server. This gives rise to the FSM state as shown at 47, where there is one call-leg, and the call server is idle.

The call is then routed by a service 48, so that the call FSM then assumes the state shown at 49 of having two call-legs, while it is routing a call. The next transition is that the other endpoint is connected at 50, giving rise to the call FSM state of having two call-legs, and being idle, as shown at 51. Finally, when one endpoint disconnects at 52, the established call once again collapses.

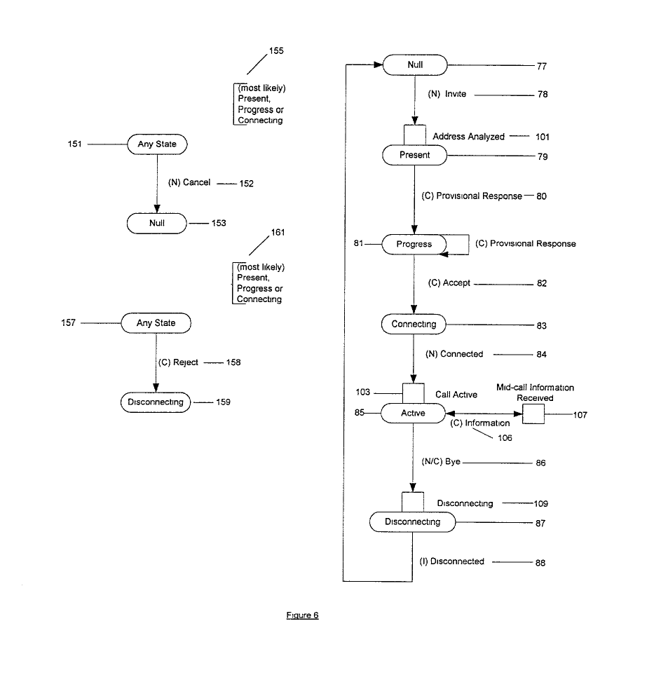

Referring now to FIG. 4, a service which is associated with the destination address may accept a call from a user, and connect the associated endpoint to a media server. At the same time, the service will find out where the called user is located. Once the called party has been located, then both parties can communicate. Again, when one endpoint disconnects, the other one will also be disconnected, and the call will be terminated.

Once again, as in FIG. 3, a new Invite message is received at 54, by a call-leg, resulting once again in the call FSM state 55 that it has one call-leg, and is processing the incoming Invite message.

This is followed, in this case, by a default behaviour transition 56, by which an internal service within the call server itself routes the call, and sends a message to that effect. Again, this gives rise to the state of the call FSM as shown at 57, where there are now two call-legs, and the call is being routed. The next transition is the service-originated message that the endpoint is to be connected to a media server, as shown at 58, again giving rise to the call FSM state as shown at 61 that there are two call-legs, and that the call server is idle. As indicated by the explanation shown at 63, however, one of the call-legs has been connected to the media server, the other is not yet active.

A service initiated transition message occurs at 62, that the call is being routed, again giving rise to the call FSM state that there are two call-legs, with a call being routed, as shown at 65. Finally, an endpoint is connected with the message being initiated by a call-leg, at 64, again giving rise to the state of the call FSM that there are two call-legs, but that the call FSM is idle, as shown at 67. The explanation shown at 69 is, however, that both call-legs are active.

Yet another scenario occurs when a call is not handled by a service, but is automatically routed to its given destination, such as a dialled address. This is shown in FIG. 5, where a new Invite message is created in a call-leg at 70, with the transition of the call FSM occurring at that time to achieve the state shown at 71 that it has one call-leg, and is processing an incoming Invite message. Again, an internal message triggers the next transition, shown at 72, which is the default behaviour that the call is being routed. This, again, gives rise to the call FSM state as shown at 73, that there are now two call-legs, and that it is routing a call.

Once the other endpoint has been connected and a message to that effect is generated from the respective call-leg so that the transition 74 has occurred, then the state of the call FSM becomes as shown at 75, that the call has two call-legs, and that the call FSM is idle.

As noted above, each call-leg may have its own finite state machine logic device associated with it. These so-called call-leg FSM's may be associated with an originating call-leg or a terminating call-leg. It will be noted from the following discussion that a call-leg FSM is not a protocol finite state machine in the sense that it may only capture the flow of network messages in and out of the call server. Rather, a call-leg FSM represents the steps that the call server will make in the process of receiving a request to join a call, or inviting a party to join a call.

A call-leg FSM will abstract the network protocol, and map it into a series of states of the respective call-leg FSM, through which states the services associated with the call server or any party to the call will perceive the processing of the call. At each of these states of the call-leg FSM, the processing of the call may be interrupted, and control of the call may be transferred to a service so that the service can decide upon the future of that call from its own point of view.

For example, upon being informed that an endpoint has been “ringing” for a certain amount of time, a service may decide to cancel the routing attempt to that endpoint, and try another destination.

Also, some services may not wish to interfere with the flow of a call, but still may want to keep track of what happens in that call. For example, a billing service may log how many times a call has been forwarded, or it may bill the length of the call or other parameters surrounding the call, without interfering with the call itself.

As any originating or terminating call-leg will eventually evolve to an active state, it may also evolve from one state to another due to a message that is received from the network, or a message that is sent by the call.

There may be a detection point existing in a call-leg FSM that manifests itself each time that there is a transition of the call-leg state to another call-leg state. The detection point thereby represents a moment during the evolution of a call when a service that is interested in controlling the call, or that is already controlling the call may be invoked, or further invoked.

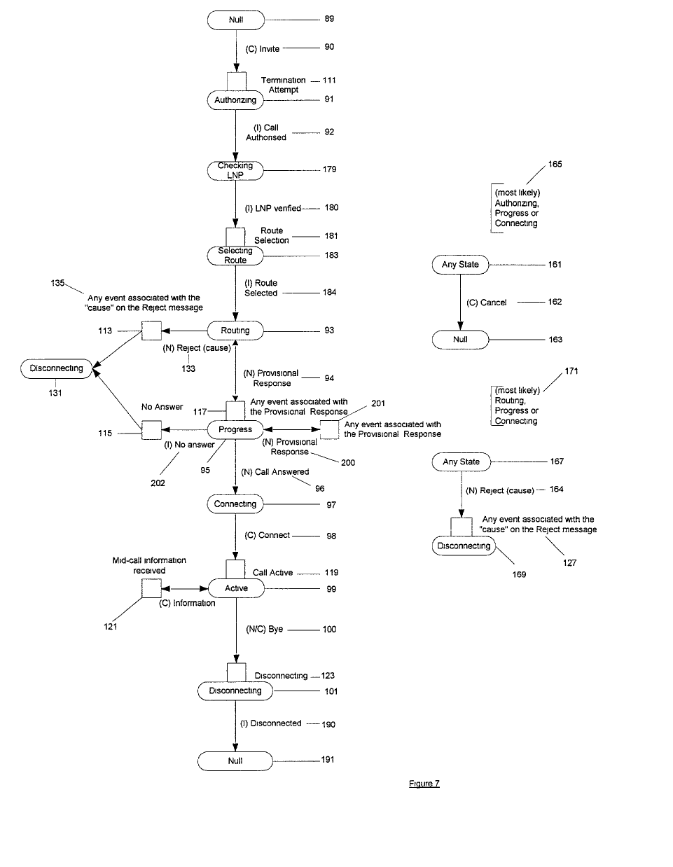

In each of FIGS. 6 and 7, which are now to be discussed, the letters “I”, “N”, and “C” as they are associated with the description of a transition, are indicative of the origin of the event that triggered that transition. Thus, the letter “I” is indicative of the fact that the event is one which is internal of the call server; the letter “N” indicates that the event that triggered the transition is network originated; and the letter “C” indicates that the event that triggered the transition is one which has been generated by the call.

Each detection point, where a service may intervene during the evolution of the call, on the respective call-leg FSM shown in FIGS. 6 and 7, is indicated by a square box associated with a respective state of the call-leg FSM being discussed. Moreover, in the following discussion, the state of the respective call-leg FSM being discussed is not in the same sense as the definitions used above with respect to the number of call-legs in a call or the current pending request, as they apply to a call FSM. Rather, the state of the call-leg FSM is, in effect, its state at any instant in time during the evolution of a call.

In an originating call-leg FSM, as shown in FIG. 6, an initial state as shown at 77 is that there is a no state for a prospective originating call-leg FSM that is to evolve. Upon receipt of a network originated Invite message with the transition shown at 78, a detection point 101 exists whereby a service may analyse the address of the caller. If the address is one which is authorized to place the call, then a state shown in 79 occurs, where the originating call-leg FSM is present. This gives rise to the next transition 80 where a message is sent to back to the caller, that the destination endpoint has been successfully contacted. The originating call-leg state is then as shown at 81, during the time while the destination point is being contacted. Then, the call accepts that response with the transition at 82 to a connecting state at 83. The transition in the call is shown then at 84, where the network event of being connected triggers that transition.

This gives rise to another detection point 103, where the call is active, and the state of the call-leg FSM is active as shown at 85. Mid-call information may then be received at 107, by virtue of an exchange of call information as shown at 106. Then, when the call is terminated by the network or as a result of the evolution of the call, giving rise to the transition 86, another detection point 109 occurs for purposes of disconnecting, giving rise to the state 87 and the disconnected transition at 88.

Also shown in FIG. 6 are several prospective actions which may occur. When the state of the call-leg FSM is in any state, but most likely present, as shown at 79, progress, as shown at 81, or connecting, as shown at 83, and as described by the conditions indicated at 155, a network originated event may occur which gives rise to a transition 152 whereby the call is cancelled. This gives rise to a state 153, where the call-leg FSM ceases to exist.

Otherwise, the state may again be as shown at 157, and described at 161, in that the state of the call-leg FSM may be present, progress, or connecting—as shown at 79, 81, and 83, but a call originated event may result in a reject transition as shown at 158. Once again, the disconnecting state 159 (as shown at 87, as well) occurs.

Turning now to FIG. 7, a terminating call-leg FSM is shown. This finite state machine logic device is understandably more complex than that which is established for an originating call-leg FSM, since most services are invoked at the terminating side of a call. That is to say, most services are triggered by the destination address of a call, rather than by the originating address of the call.

Once again, the assumption is made that the first state is that which is shown at 89, that there is a no terminating call-leg FSM. The call attempts to send an Invite message, giving rise to transition 90, will result in a state where the terminating call-leg FSM is authorizing the call. However, a detection point 111 may occur, which may result in a termination attempt which might occur as a consequence of a particular service associated with the destination address being called.

Once the internal call authorised transition occurs, as shown at 92, the state reverts to checking LNP (Line Number Portability) as shown at 179. At this state the destination address may need to be verified as to whether it has been ported on the network. When the internal event LNP verified occurs at 180, the detection point route selection is then verified, as shown at 181, when a service interested in this event may be triggered. The terminating call-leg FSM logic device then transverses the state selecting route, as shown at 183, where either a service selects the route for the current destination—according to its own internal policy, or the Call Server decides the route according to its internal rules.

Once the internal route selected transition occurs, as shown at 184, the state reverts to a routing state as shown at 93, followed by a provisional response transition based upon a network-originated message as shown at 94. A progress state occurs then at 95, but this results as well in a detection point at 117. While on the routing state, multiple provisional responses may be received from the network, as described by 200, for each of those messages a detection point is visited as shown at 201.

Indeed, there is another detection point 113 which may occur while the terminating call-leg FSM assumes its routing state as shown at 93, and that is that there could be a reject message generated, as shown at 133. If so, then at the decision point 113 a check will be made as to whether or not there is any service that is interested in that call, having a reject message with a specific cause in which a service may be interested. If not, then a disconnect occurs as shown at 131.

Likewise, as a consequence of the no answer internal event at 202, a no answer detection point 115 may occur. Thus, either the reject message detection point 113 or the no answer detection point 115 will result in a disconnecting state 131.

However, if the call is answered with the transition shown at 96, a state of connecting for the terminating call-leg FSM occurs at 97, followed by the connect transition at 98. The state is then active, as shown at 99, but this again gives rise to a detection point 119 where an intervention may occur with respect to the call. While on the active state as shown at 99, mid-call information maybe collected as shown at 121.

Upon termination, arising in the transition 100 on the network, or by the call, the disconnecting state 101 occurs with, once again, a detection point 123 being effected. Again, any service may intervene at that time, and, for example, re-route the call, collect additional billing information, and so on.

When the terminating call-leg FSM is in a state of evolution—that is, any state 161, most likely authorizing, progress, or connecting, as shown at 165—a call originated event may occur whereby the call is cancelled as at 162, which dissolves the terminating call leg FSM logic device, as shown at 163.

Likewise, any state 167 which may most likely be authorizing, present, or connecting as shown at 171, may be affected by a network originated event whereby the call is rejected, as shown at 164. For example, a detection point 127, determining that the called destination is busy, may occur. However, that may result, as well, in a state of disconnecting, as shown at 169.

Note that on both FIGS. 6 and 7, not all possible transitions have been shown, for whenever a visited detection point does trigger the execution of a service, this service may modify the default behaviour described on the transitions by indirectly setting the next state of the FSM logic device to another valid one.

A flexible call server has been described, which will support different types of calls both with regard to the number of participants, as well as to how the call establishment has been initiated. As noted, the call may have been initiated by the network, or by a service which is executed on the call server itself.

Various scenarios of the finite state machine associated with the call server have been discussed: and various scenarios associated with a finite state machine which may be established for any call-leg has also been discussed.

Other modifications may occur with respect to the call server of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

What is claimed is:

1. A call server which permits from zero to multiple call-legs per call, and which permits multiple services independently of the number of participants in any call;
said call server being adapted to establish a finite state machine logic device for each call that is being established, so as to capture the evolution of the call during its lifetime, and to enable the call server to handle and process signalling messages from endpoints associated with the call, and requests from call services running on said call server during any call;
wherein said finite state machine logic device changes state during the progress of a call, in keeping with instructions received thereby as the call evolves; and
wherein at any time, any service associated with any call-leg of said call may alter the processing of the call in keeping with predetermined instructions associated with that service.

2. The call server of claim 1, wherein said finite state machine is a call finite state machine, and is such as to permit a call to be initiated by any one of a call service associated with said call server, or an endpoint which is associated with said call server.

3. The call server of claim 2, further comprising a finite state machine for an originating call-leg between an originating endpoint, and said call server.

4. The call server of claim 2, wherein a call includes a plurality of destination endpoints, and a corresponding plurality of terminating call-legs, and wherein said call server further comprises at least one finite state machine for at least one of said terminating call-legs between said call server and any destination endpoint for said call.

5. The call server of claim 2, wherein a plurality of services are permitted to run contemporaneously in association with any call-leg of a call.

6. The call server of claim 2, wherein a state of said call finite state machine logic device is defined by the number of call-legs at any instant in time during the lifetime of a call.

7. The call server of claim 2, wherein a state of said call finite state machine logic device is defined as a consequence of any signalling messages received thereby from any network endpoint associated with that call, or of any requests received thereby from any call service running on said call server.

8. The call server of claim 6, wherein a state of said call finite state machine logic device is chosen from the group consisting of: zero call-legs, one call-leg, two call-legs, and multiple call-legs.

9. The call server of claim 7, wherein a state of said call finite state machine logic device is chosen from the group consisting of: processing incoming Invite, routing call, and idle.

10. The call server of claim 2, wherein auxiliary information is kept by said call finite state machine logic device on a per call-leg basis, for each call-leg associated with a call.

11. The call server of claim 3, wherein a detection point exists in said finite state machine for said originating call-leg, at any transition of said originating call-leg from one state to another, whereby any service associated with that call-leg may be invoked by said call server.

12. The call server of claim 4, wherein a detection point exists in said at least one finite state machine for said at least one terminating call-leg of the call, at any transition of said at least one terminating call-leg from one state to another, whereby any service associated with any respective at least one terminating call-leg may be invoked by said call server.
